(19) United States
(12) Patent Application Publication
(10) Pub. No.: US 2013/0268510 A1
(43) Pub. Date: Oct. 10, 2013

(54) Special form of presentation of search results

(71) Applicant: Edgore L. Milberg, Newton, MA (US)

(72) Inventor: Edgore L. Milberg, Newton, MA (US)

(21) Appl. No.: 13/441,708

(22) Filed: Apr. 6, 2012

(51) Int. Cl. G06F 17/30

(52) U.S. Cl. 707/722; 707/E17.014

(57) ABSTRACT

The invention is a method for presenting search results in special form. This form consists of several components. In aggregate, all the components encompass such characteristics of a search query as a source position, quantity of full and partial matches and coefficient of relevance (COR). Also the form allows the users manipulate the values of characteristics of the search query.

### BACKGROUND OF THE INVENTION

### Field of the Invention

The invention pertains to search systems industry.

### BRIEF SUMMARY OF THE INVENTION

The inventive concept of the invention is to form a complete picture of origin of the search results. It is also intended to give the users basic instruments for manipulation of the search query. The advantages of the invention include but not limited:
1. Completeness of the search results;
2. Simplicity in use;
3. High flexibility in manipulation of the search query.

### BRIEF DESCRIPTION OF THE DRAWINGS

FIG. 1 is a flowchart describing realization of the invention.

FIG. 2. shows general picture of search result page.

FIG. 3. shows a form of the search result in case if the search query was found in a heading.

FIG. 4. shows a form of the search result in case if the search query was found in a website link.

FIG. 5. shows how one of characteristics of the search query such as full matches might be looked like.

FIG. 6. shows a way the user can review all the links of a website.

FIG. 7. shows how Direct search option works.

### DETAILED DESCRIPTION OF THE INVENTION

The invention is realized as a computer program. This program is a main program that comprises of several internal programs. The process of execution of the main program is divided into several steps as follows:

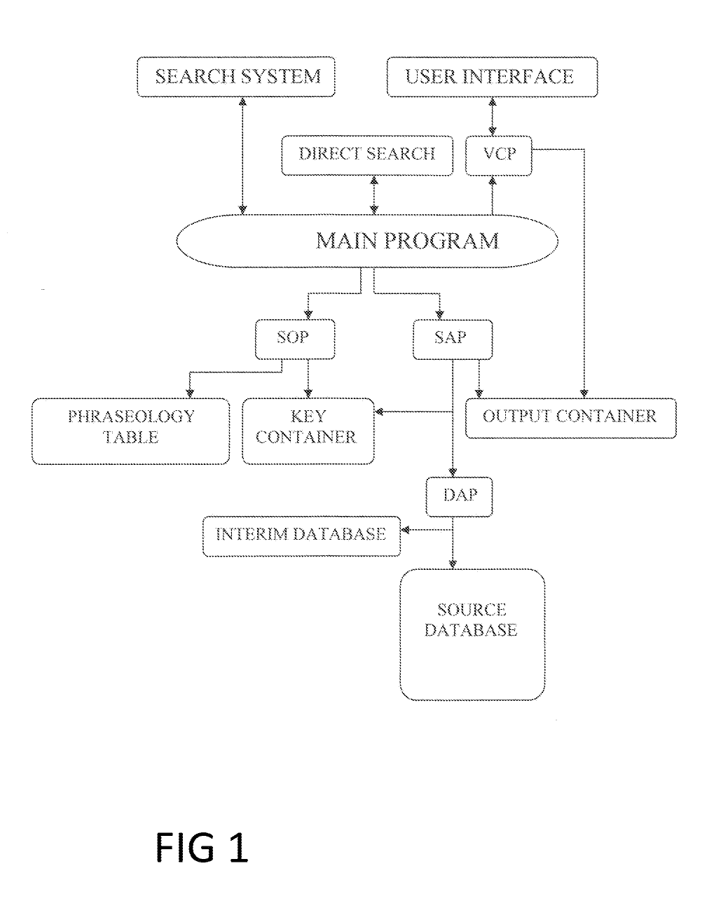

Step 1: The main program is launched when it gets a search query from a search system or through a direct search option. Search system herein is a system whose prime purpose is to search any kind of information. It can be any kind of search engine. Direct search option herein is an option that allows the users to enter a search query. FIG. 1 shows that the search query can be received by two methods, explicit and implicit. The explicit method is a method when the search query is received by the main program from a search system. The implicit one is a method when the search query is directly received from a user.

Step 2: When the main program gets a search query it calls SOP. First, SOP determines a semantic context of the search query. Second, SOP checks an orthographical structure of the search query with help of phraseology table. The phraseology table consists of a big variety of frequently used phrases. Outcome of SOP's work is a list of phrases (queries). The phrases are very close to user-entered query in terms of relevance. Then the phrases are saved in Key container. See FIG. 1. Key container is equivalent to Output container in terms of data format.

Step 3: At this point the main program passes the control to search analysis program (SAP). Then. SAP calls database access program (DAP). DAP is responsible for working with a source database. SAP asks DAP for an access to database. Once the access is granted SAP checks the interim database for query that is equivalent the current one.

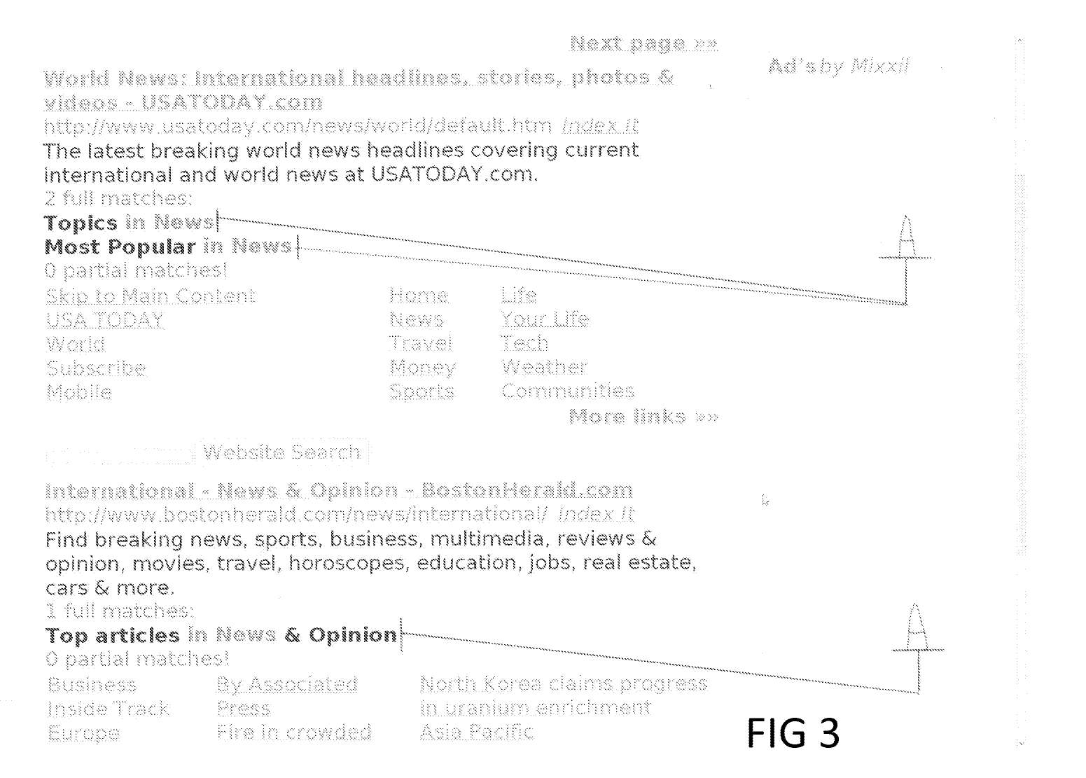

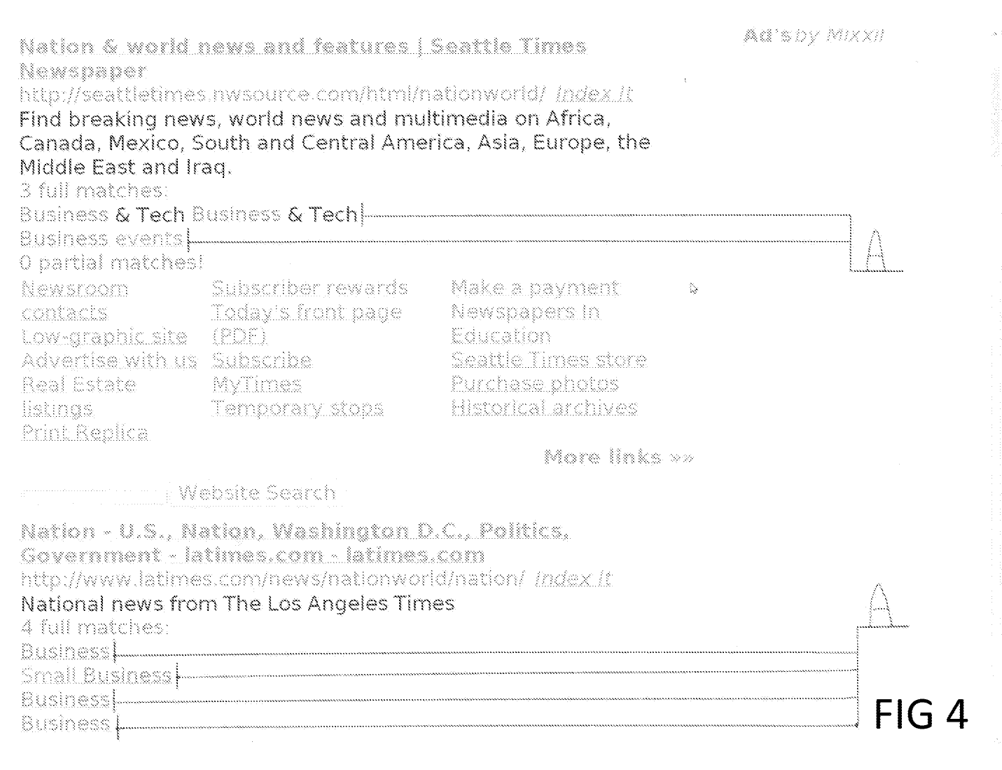

If the equivalent query was found then all data related to the query will be extracted from the source database and saved in Output container. See FIG. 1. The data saved in Output container is presented in the form of associative table. One of the fields of the associative table is a source position. In website context it means a tag position where the search query was found. For example, if the search query was found in a heading then the users will see the heading (A) where the search query is presented. See FIG. 3. If the search query was found, say, in a link then the users will see the link (A) where the search query is presented. See FIG. 4.

Thus the search query on search result page will be presented in form according to a website tag within which the search query was found.

Before saving the associative table is sorted by the values of COR from top to bottom. The values of CUR are formed according to table of precedence of the website tags (from top to bottom):
1. Heading tag;
2. Link tag;
3. Symbol tag, which is any kind of tag comprising of alphanumeric text.
4. All other tags that are not listed above.

If the equivalent query was not found then. SAP starts searching in the source database. From this point SAP can act as follows:
1. If the query was found SAP will save it in Output container and return the control to the main program;
2. As in above-said but additionally SAP will launch a search on queries (phrases) found in Key container and save the results in Output container;
3. If SAP doesn't find the search query it takes the queries (phrases) from Key container and proceeds searching. Then the result will be saved in Output container.

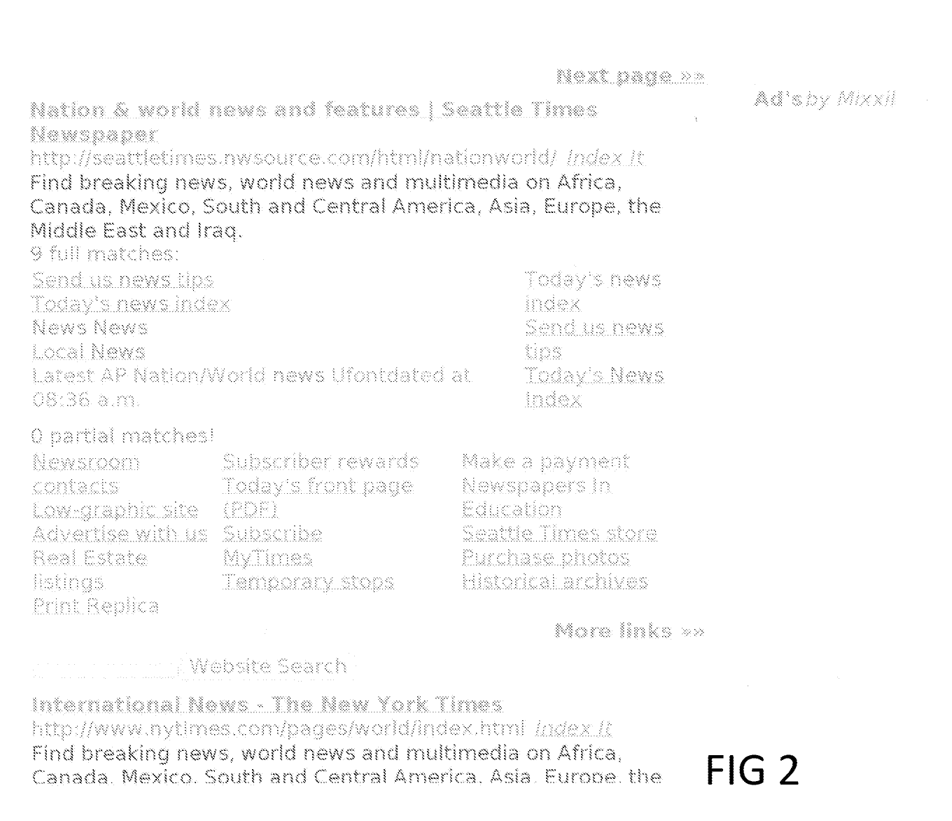

Step 4: After getting the control from SAP the main program calls VCP. VCP is responsible for a visualization of the search results. VCP starts its work by downloading the associative table related to the current search query in buffer. Then VCP attempts to get information from a user output device (user interface). See FIG. 1. The information is about screen resolution, fonts and so on. In final step, VCP uploads the associative table from the buffer to a user output device in form showed in FIG. 2.

Once the search query is changed by the user all the steps are resumed from Step 1.

As for a website search the form of presentation of the search results consists of several components.

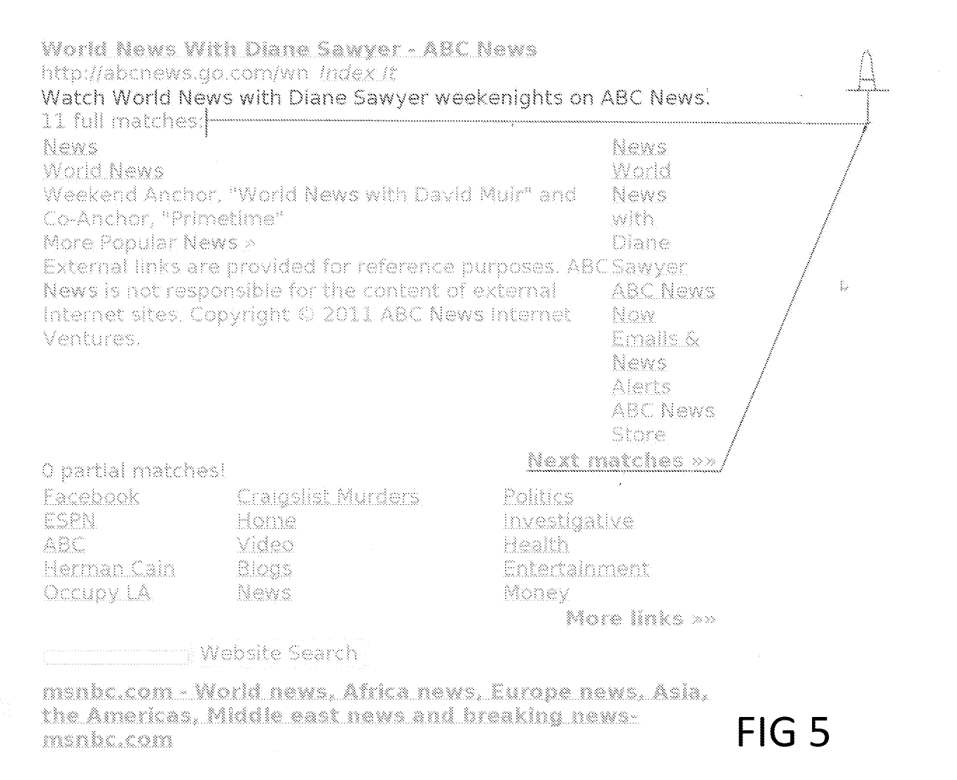

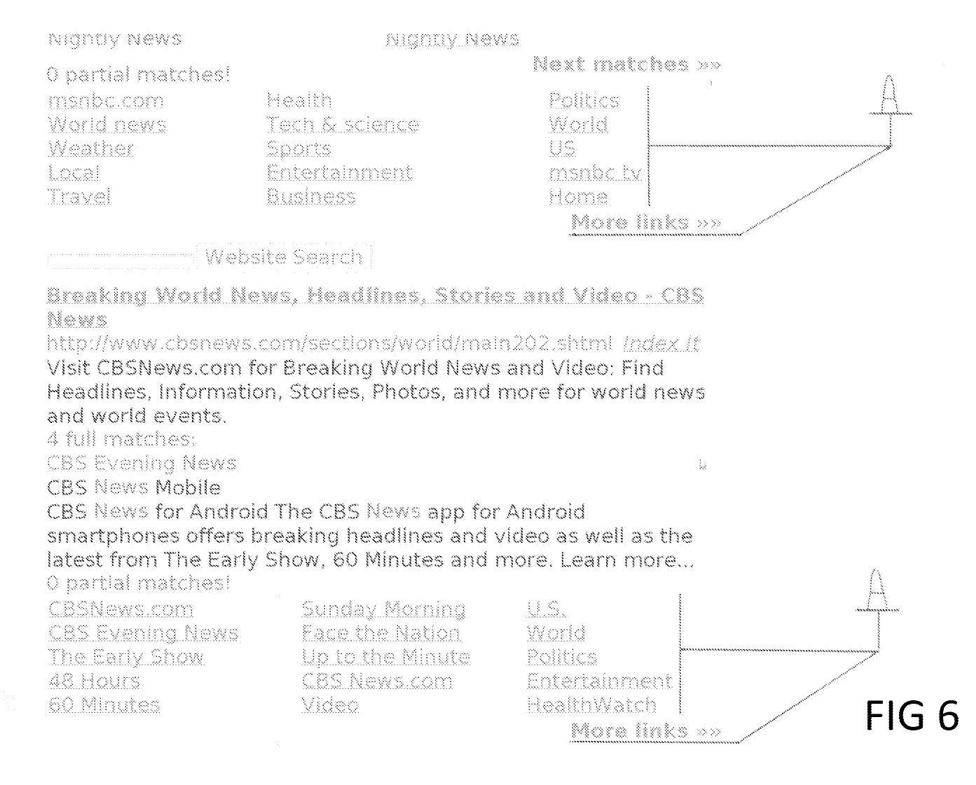

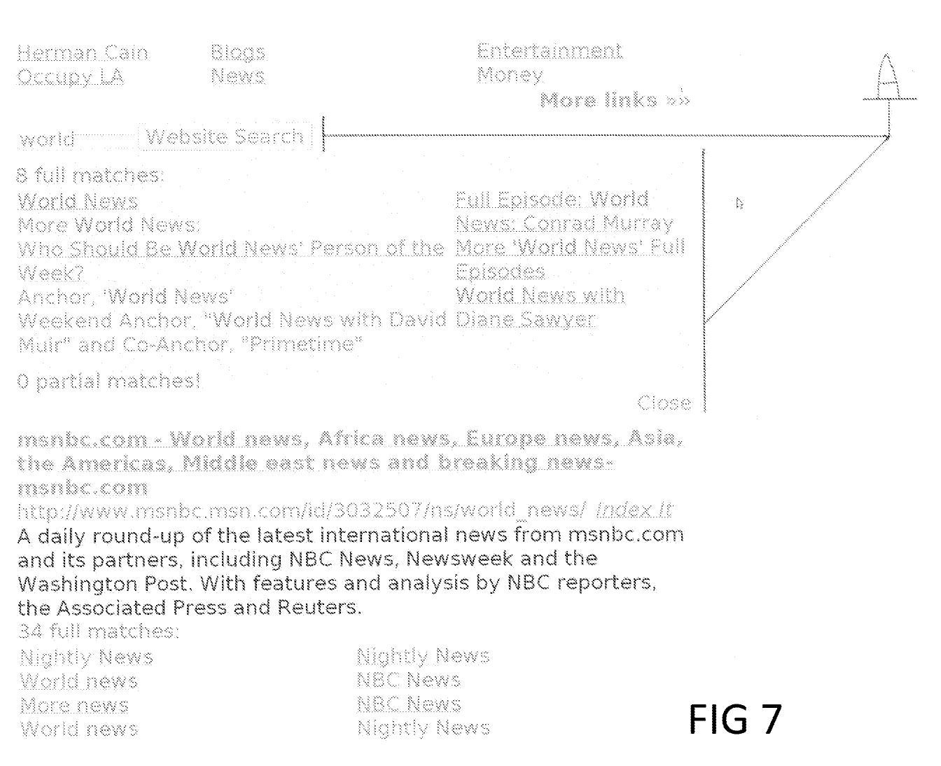

FIG. 5 shows how the search result page might be looked like if such component as full matches has more than ten results (A). FIG. 6 shows how the user can review all the links (A) of a website. FIG. 7 shows a situation when the user decides to change the search query by using Direct search option (A). See also FIG. 1.

In general, the invention gives the users a complete collection of data with detailed information about the origin of the found search query. It extremely decreases time for searching and, what is also important for the users, an opportunity to see and manipulate the degree of relevance of the search results.

1. A method for presentation of the search results in special form comprises of: (a) getting a search query; (b) treatment of the search query by semantic orthography program (SOP); (c) getting an access to a source database of any kind; (d) checking an interim database; (e) forming an associative table according to characteristics of the search query; (f) sorting values of the associative table; (g) saving the associative table to an output container; (h) displaying the search results on a user output device.

2. The method of claim 1, wherein a search query is a group of any kind of symbols the user wants to find in websites. The group can consist of one or more symbols.

3. The method of claim 1, wherein semantic orthography program comprises of a process of analyzing the search query through the semantic and orthographical context;

4. The method of claim 1, wherein a source database means a database that includes complete information about indexed websites, directories and other structural types of data.

5. The method of claim 1, wherein interim database is a database that is used for saving previously found search queries;

6. The method of claim 1, wherein forming an associative table according to characteristics of the search query comprises of: (c1) creating an empty associative table; fields of the table are titled according to the names of the characteristics; the list of the characteristics depends on a structure of source database what the search is on; (c2) indexing the database and filling the table out.

7. The method of claim 1, wherein sorting values of the associative table comprises of a process of sorting the values according to the coefficient of relevance, from top to bottom.

8. The method of claim 1, wherein an output container is a place where the associative table can be saved; it might be a text file in a folder, an entry in a database and so on;

9. The method of claim 1, wherein user output device is a device such as a monitor of computer, iPhone, iPad, smart phone.
